(19) United States
(12) Patent Application Publication
(10) Pub. No.: US 2015/0070263 A1
(43) Pub. Date: Mar. 12, 2015

(54) Dynamic Displays Based On User Interaction States

(71) Applicant: Microsoft Corporation, Redmond, WA (US)

(72) Inventors: Oscar Murillo, Seattle, WA (US); Richard Bailey, Redmond, WA (US)

(73) Assignee: Microsoft Corporation, Redmond, WA (US)

(21) Appl. No.: 14/021,968

(22) Filed: Sep. 9, 2013

(51) Int. Cl. G06F 3/01

(52) U.S. Cl. CPC G06F 3/011; G06F 3/017
USPC 345/156

(57) ABSTRACT

A system and method enabling dynamic interaction between users and displays. Interaction states for a user are determined by tracking user motions and position within the field of view of one or more capture devices. Interaction states are defined by any number of factors, including one or more of a user's body position, body orientation. Once a user occupies an interaction state, an associated application layout is applied to a display. Application layout states may include which application objects are displayed for a given interaction state. Triggering an application state is driven by a transition event and a determination that a user occupies an interaction state. Monitoring user motion and position may be performed continuously, so that changes in interaction states can be determined and corresponding changes to application layout states can be applied to a display, thereby rendering the technology dynamic to user movement.

### BACKGROUND

In the past, computing applications such as computer games and multimedia applications have used controllers, remotes, keyboards, mice, or the like to allow users to manipulate game characters or other aspects of an application. More recently, computer games and multimedia applications have begun employing cameras and motion recognition to provide a human computer interface (“HCI”). With HCI, user gestures are detected, interpreted and used to control game characters or other aspects of an application.

Controllers are generally associated with a display screen. Some screens are touch sensitive, while others are passive. Currently, digital screens do not tend to react to what people do in front of them until such time as the user actually touches the screen or manipulates a controller coupled to the screen. Generally, users adjust their position and orientation relative to the display in order to optimize their experience with the display.

### SUMMARY

Technology is provided to enable displays to react and optimize a user experience based on user interaction states. User movement and position is tracked in a field of view. Tracking information is used to determine a user interaction state. Interaction states are defined relative to one or more of a user's body position, body orientation, body range, head range, head position, head orientation, dwell time for each of the range/orientation/positions, user motion, user posture, user gaze and user auditory cues. Once an interaction state is determined, a computer implemented application controlling display objects on the display can optimize any number of display components to provide an improved user experience. Interaction states are defined and linked to application layout states for a variety of different applications and processing systems.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1a illustrates one embodiment of a target recognition, analysis and tracking system with a user performing a gesture to control a user-interface.

FIG. 1b illustrates one embodiment of a target recognition, analysis and tracking system with a user performing a gesture to control a user-interface.

FIG. 2 illustrates one embodiment of a capture device in accordance with the present technology.

FIG. 3 illustrates a method of tracking user activity relative to a capture device.

FIG. 4 is a flow chart illustrating a method in accordance with the present technology.

FIGS. 5a and 5b illustrate a user in an application state and the resulting associated application layout on a display for a calendar application.

FIGS. 6a and 6b illustrate a user in another application state and the resulting associated application layout on a display for a calendar application, showing the change relative to the state illustrated in FIG. 5a-5b.

FIGS. 7a and 7b illustrate a user in another application state and the resulting associated application layout on a display for a calendar application, showing the change relative to the state illustrated in FIG. 5a-6b.

FIG. 8 illustrates the change to the application where a user changes a orientation factor relative to the interaction state and the application state.

FIGS. 9a and 9b illustrate the effect of user posture relative to application states.

FIGS. 10a and 10b illustrate changes in functionality of an application state based on an interaction state where a user is disengaged versus fully engaged, as defined by the factors making up an interaction state.

FIG. 11 illustrates factors comprising an interaction state definition.

FIG. 12 is a flowchart illustrating a method of determining whether a user is in an interaction state and finding an associated application state for that interaction state.

FIG. 13 is a flowchart illustrating a method for determining a transition event.

FIG. 14 is a block diagram of a first processing device.

FIG. 15 is a block diagram of a second exemplary processing device.

### DETAILED DESCRIPTION

Technology is provided to enable users to interact with displays and for information to be provided to the user based on the user's intention to interact. The solution defines a set of application layout states which are associated with user interaction states, and transitions between these states. Interaction states are determined by tracking user motions and position within the field of view of one or more capture devices. Interaction states are defined by any number of factors, including one or more of a user's body position, body orientation, body range, head range, head position, head orientation, dwell time for each of the range/orientation/positions, user motion, user posture, user gaze and user auditory cues. The capture devices may be positioned in relation to a display such that the user's position and orientation relative to the display are known. Interaction states are determined based on a number of factors identifying the user position and orientation within the field of view. Each of the application layout states includes an application display layout, which includes a set of information and display settings to be presenting in the application display layout. The display settings for a layout may include font sizes, picture sizes, and other standard layout element characteristics. Application layout states may include which application objects are displayed for a given interaction state. Triggering an application state is driven by a transition event and a determination that a user occupies an interaction state. Monitoring user motion and position may be performed continuously, so that changes in interaction states can be determined and corresponding changes to application layout states can be applied to a display, thereby rendering the technology dynamic to user movement.

In one embodiment, the technology is implemented with a target, analysis and tracking system 10. In alternative embodiments, any type of suitable user tracking device gathering user position, orientation and motion can be utilized with the technology.

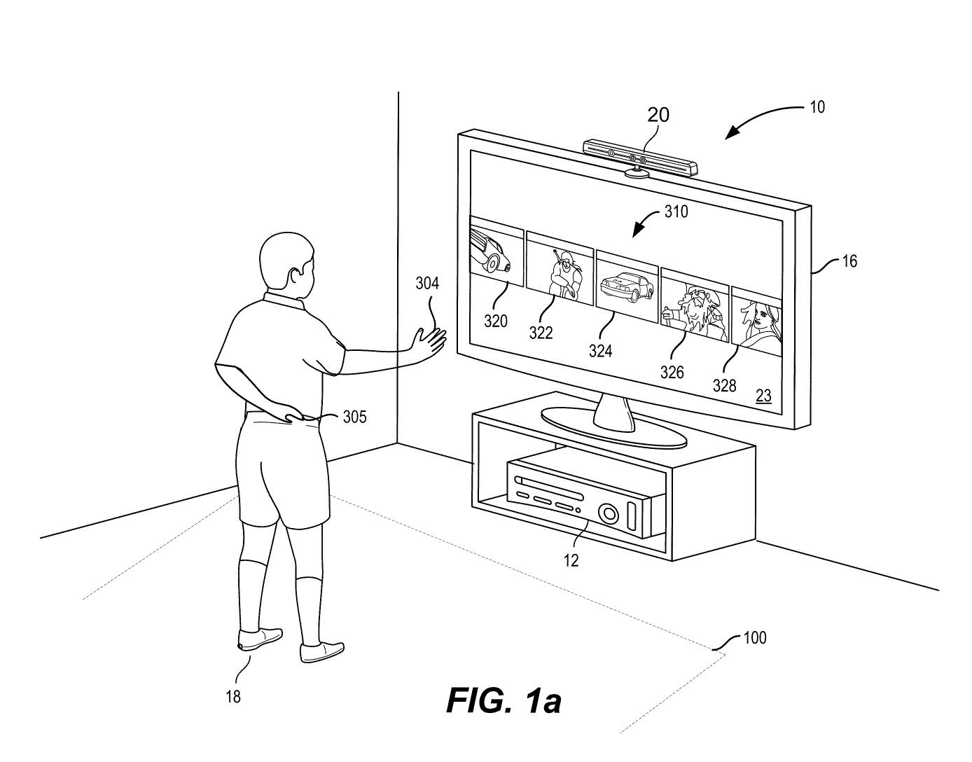

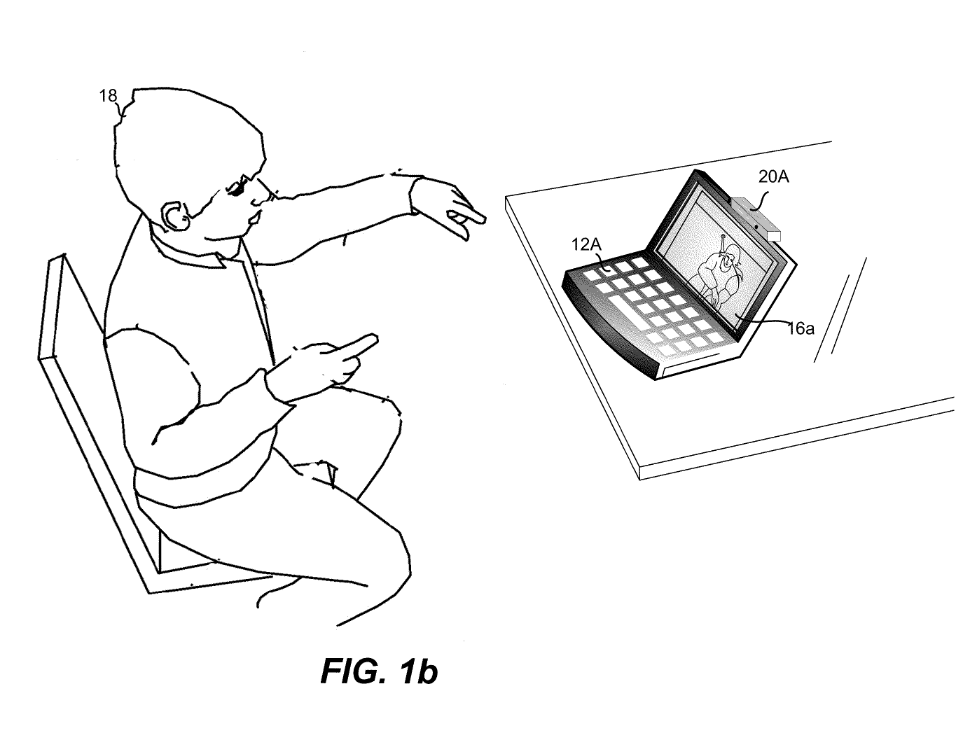

FIG. 1 illustrates one embodiment of a target recognition, analysis and tracking system 10 (generally referred to as a tracking system hereinafter) with a user 18 interacting with a system user-interface list 310. The target recognition, analysis and tracking system 10 may be used to recognize, analyze, and/or track a human target such as the user 18, and provide a human controlled interface.

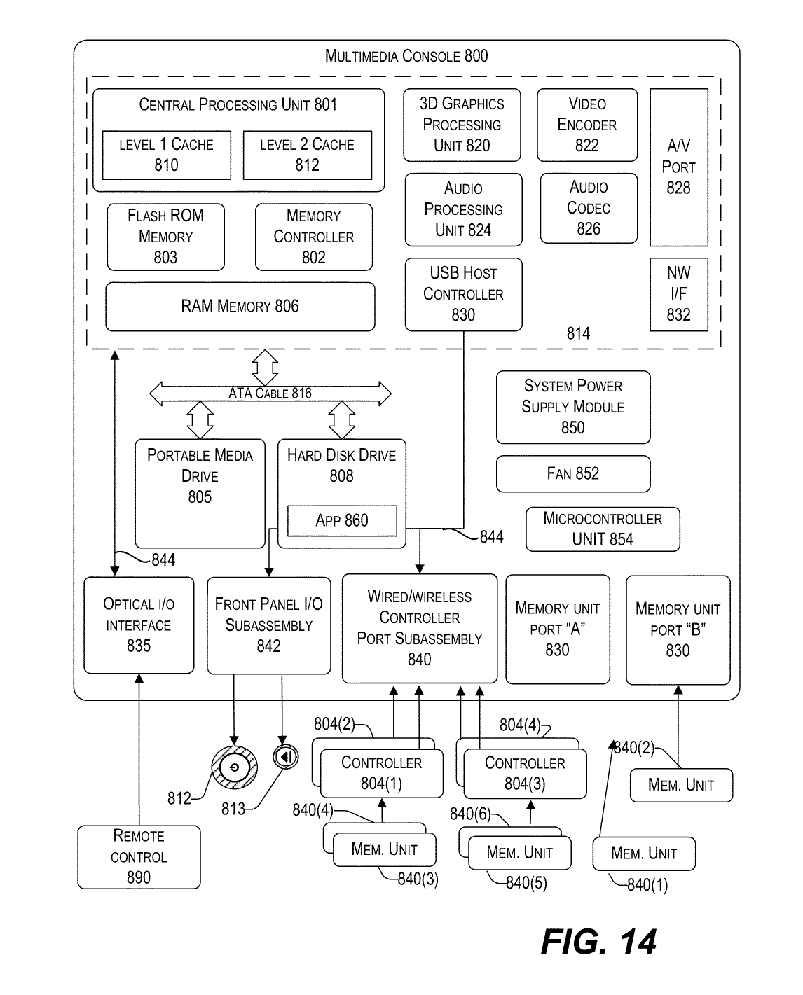

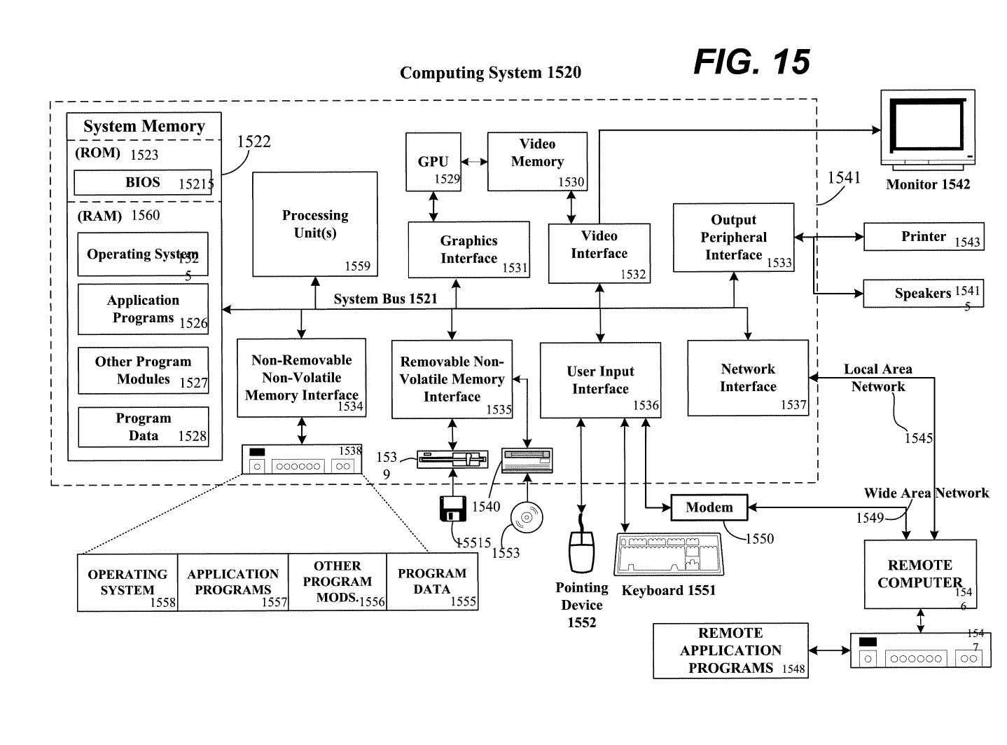

As shown in FIG. 1, the tracking system 10 may include a computing environment 12. The computing environment 12 may be a computer, a gaming system or console, or the like, such as those illustrated in FIGS. 14 and 15 herein. According to one embodiment, the computing environment 12 may include hardware components and/or software components such that the computing environment 12 may be used to execute an operating system and applications such as gaming applications, non-gaming applications, or the like. In one embodiment, computing environment 12 may include a processor such as a standardized processor, a specialized processor, a microprocessor, or the like that may execute instructions stored on a processor readable storage device for performing the processes described herein.

As shown in FIG. 1, the tracking system 10 may further include a capture device 20. The capture device 20 may be, for example, a camera that may be used to visually monitor one or more users, such as the user 18, such that motion and positions of one or more users may be determined and used to determine whether a user is in an interaction state to generate a dynamic display based on a defined application layout state.

The capture device may be positioned on a three-axis positioning motor allowing the capture device to move relative to a base element on which it is mounted. The positioning motor allows the capture device to scan a greater range of a physical environment 100 in which the capture device 20 is places.

According to one embodiment, the tracking system 10 may be connected to an audiovisual display 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual display 16 may receive the audiovisual signals from the computing environment 12 and may output application visuals and/or audio associated with the audiovisual signals to the user 18. According to one embodiment, the audiovisual display 16 may be connected to the computing environment 12 via, for example, an S-Video cable, a coaxial cable, an HDMI cable, a DVI cable, a VGA cable, or the like.

As shown in FIG. 1a, the target recognition, analysis and tracking system 10 may be used to recognize, analyze, and/or track one or more human targets such as the user 18. For example, the user 18 may be tracked using the capture device 20 such that the movements of user 18 may be interpreted as controls that may be used to affect an application or operating system being executed by computer environment 12.

Consider a user interface application executing on the computing environment 12. The user 18 may make movements which may be recognized and analyzed in physical space. Some movements may be interpreted as controls that may correspond to actions that control an application function. For example, the player may use movements to end, pause, or save a game, select a level, view high scores, communicate with a friend, etc.

In FIG. 1, user 18 is interacting with the tracking system 10 to control the system user-interface (UI), which in this particular example is displaying a list 310 of menu items 320-330. The individual items may represent applications or other UI objects. A user may scroll left or right (as seen from the user's point of view) through the list 310 to view other menu items not in the current display but also associated with the list, select menu items to trigger an action such as opening an application represented by the menu item or further UI controls for that item. The user may also move backwards through the UI to a higher level menu item in the UI hierarchy.

Each of the items 320-330 may be considered display objects within the context of this application.

In the example of FIG. 1, user 18 is positioned in an interaction state which has an associated application layout of the list 310 with menu items 320-330. Given the user's body position, body orientation, body range, head range, head position, head orientation, dwell time in each of the range/orientation/positions, user motion, user posture, user gaze and/or user auditory cues, an application layout for this UI has been set to display the illustrated application layout. As the user changes one or more of the aforementioned factors, the application layout may change. Application layouts may be defined as discussed herein.

Generally, as indicated in FIG. 1, a user 18 is tracked in a physical environment 100, which may be referred to herein as the field of view of the capture device 20. The environment 100 is generally the performing range of the capture device 20. It should be understood that while environment 100 is illustrated in two dimensions in FIG. 1a, the environment 100 is three-dimensional.

In other embodiments, as illustrated in FIG. 1B, a user 18 can be positioned before a notebook computer processing device 12A and a capture device 20A in a smaller field of vision at a distance closer to the capture device than illustrated in FIG. 1a. In the illustration on FIG. 1b, the processing device 12A is a notebook computer, and the distance between user 18 and the capture device 20A is much smaller than the embodiment depicted in FIG. 1A. In addition, because the user is closer to the capture device, the field of view of the capture device is smaller. All other elements being equal, a capture device positioned closer to the user 18 as illustrated in FIG. 1B with a resolution equivalent to that of capture device 20 in FIG. 1A will have a greater ability to capture the user's finger and facial movements. In such cases, additional factors for interaction states may be defined including, for example, a user hand position, finger position, and the like.

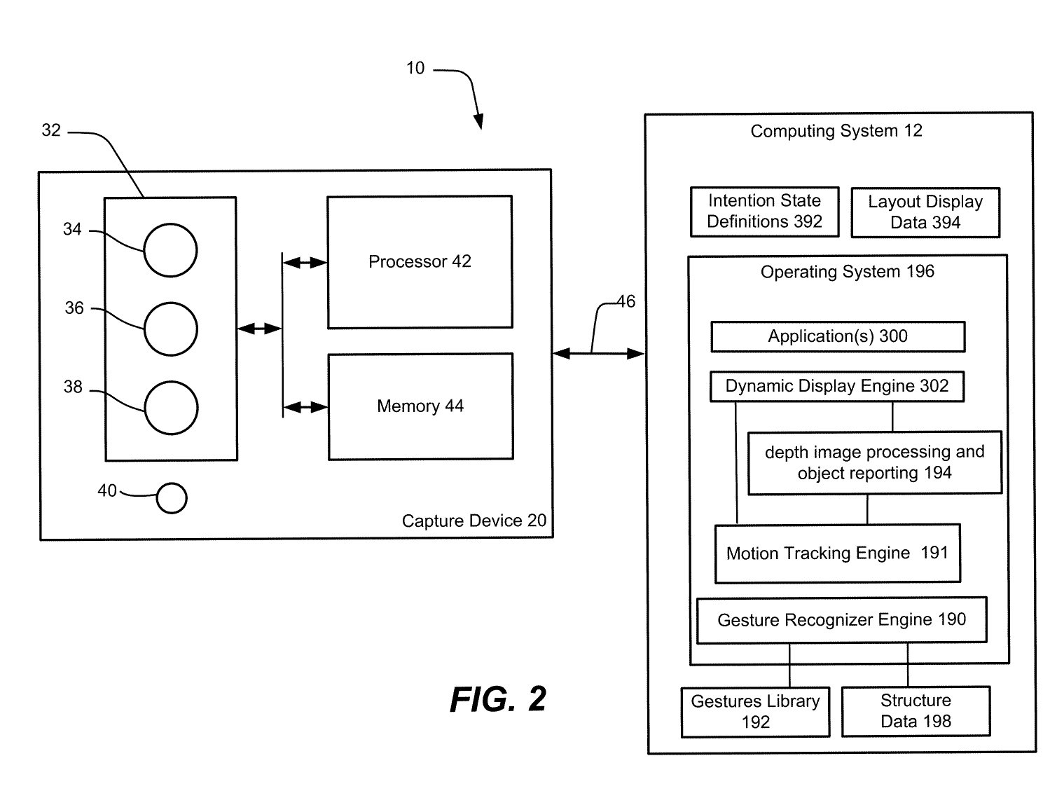

FIG. 2 illustrates one embodiment of a capture device 20 and computing environment 12 that may be used in the target recognition, analysis and tracking system 10 to recognize human and non-human targets in a capture environment 100 (without special sensing devices attached to the subjects), uniquely identify them and track them in three dimensional space. According to one embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z-axis extending from the depth camera along its line of sight, or “z-layers” defined as spherical as a distance from the sensor center rather than planar distance along the z-axis from the sensor.

As shown in FIG. 2, the capture device 20 may include an image camera component 32. According to one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2, the image camera component 32 may include an IR light source 34, a three-dimensional (3-D) camera 36, and an RGB camera 38 that may be used to capture the depth image of a capture area. For example, in time-of-flight analysis, the IR light source 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light source 34. Upon striking the surface of one or more targets or objects in the capture area, the pattern may become deformed in response. Such a deformation of the pattern may be captured by, for example, the 3-D camera 36 and/or the RGB camera 38 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

The capture device 20 may further include a microphone 40. The microphone 40 may include a transducer or sensor that may receive and convert sound into an electrical signal. According to one embodiment, the microphone 40 may be used to reduce feedback between the capture device 20 and the computing environment 12 in the target recognition, analysis and tracking system 10. Additionally, the microphone 40 may be used to receive audio signals that may also be provided by the user to control applications such as game applications, non-game applications, or the like that may be executed by the computing environment 12.

In one embodiment the microphone 40 comprises array of microphone with multiple elements, for example four elements. The multiple elements of the microphone can be used in conjunction with beam forming techniques to achieve spatial selectivity In one embodiment, the capture device 20 may further include a processor 42 that may be in operative communication with the image camera component 32. The processor 42 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

Processor 42 may include an imaging signal processor capable of adjusting color, brightness, hue, sharpening, and other elements of the captured digital image.

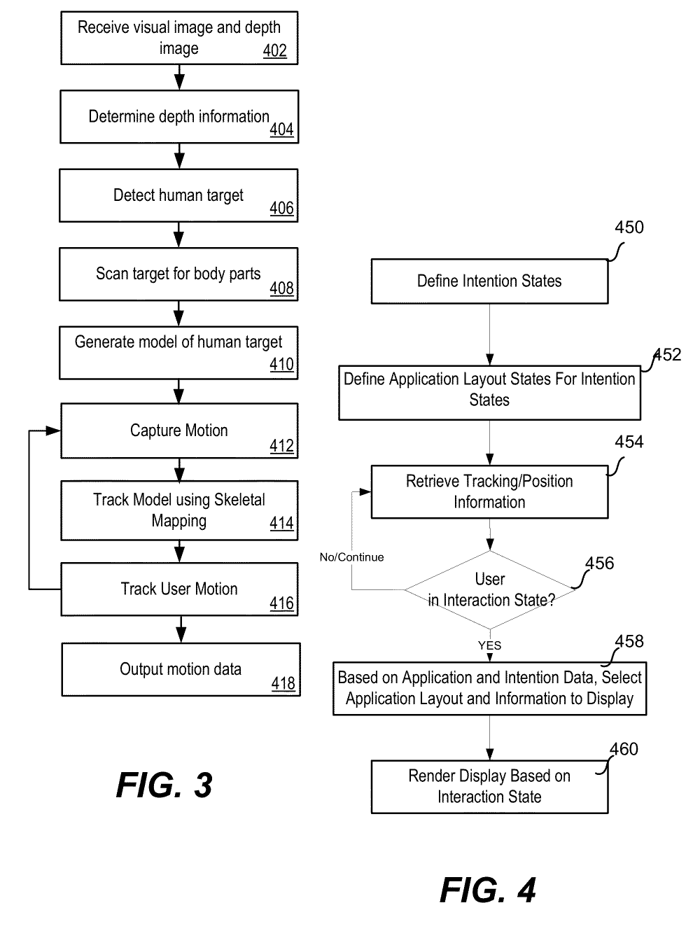

The capture device 20 may further include a memory component 44 that may store the instructions that may be executed by the processor 42, images or frames of images captured by the 3-D camera or RGB camera, user profiles or any other suitable information, images, or the like. According to one example, the memory component 44 may include random access memory (RAM), read only memory (ROM), cache, Flash memory, a hard disk, or any other suitable storage component. As shown in FIG. 3, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 2 are housed in a single housing.

The capture device 20 may be in communication with the computing environment 12 via a communication link 46. The communication link 46 may be a wired connection including, for example, a USB connection, a Firewire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46.

The capture device 20 may provide the depth information and images captured by, for example, the 3-D camera 36 and/or the RGB camera 38, including a skeletal model that may be generated by the capture device 20, to the computing environment 12 via the communication link 46. The computing environment 12 may then use the skeletal model, depth information, and captured images to, for example, create a virtual screen, adapt the user interface and control an application such as a game or word processor.

A motion tracking system 191 uses the skeletal model and the depth information to provide a control output to an application on a processing device to which the capture device 20 is coupled. The depth information may likewise be used by a gestures library 192, structure data 198, gesture recognition engine 190, depth image processing and object reporting module 194 and operating system 196. Depth image processing and object reporting module 194 uses the depth images to track motion of objects, such as the user and other objects. The depth image processing and object reporting module 194 may report to operating system 196 an identification of each object detected and the location of the object for each frame. Operating system 196 will use that information to update the position or movement of the user relative to objects or application in the display or to perform an action on the provided user-interface. To assist in the tracking of the objects, depth image processing and object reporting module 194 uses gestures library 192, structure data 198 and gesture recognition engine 190.

The computing environment 12 may include one or more applications 300 which utilize the information collected by the capture device for use by user 18. Structure data 198 includes structural information and skeletal data for users and objects that may be tracked. For example, a skeletal model of a human may be stored to help understand movements of the user and recognize body parts. Structural information about inanimate objects may also be stored to help recognize those objects and help understand movement.

Gestures library 192 may include a collection of gesture filters, each comprising information concerning a gesture that may be performed by the skeletal model (as the user moves). A gesture recognition engine 190 may compare the data captured by the cameras 36, 38 and device 20 in the form of the skeletal model and movements associated with it to the gesture filters in the gesture library 192 to identify when a user (as represented by the skeletal model) has performed one or more gestures. Those gestures may be associated with various controls of an application. Thus, the computing environment 12 may use the gestures library 192 to interpret movements of the skeletal model and to control operating system 196 or an application (not shown) based on the movements.

A dynamic display engine 302 interacts with applications 300 to provide an output to, for example, display 16 in accordance with the technology herein. The dynamic display engine 302 utilizes interaction state definitions 392 and layout display data 394 to determine dynamic display states on the output display device in accordance with the teachings herein.

In general, the dynamic display engine 302 determines a user interaction state based on a number of data factors as outlined herein, then uses the state to determine an application layout state for information provided on the display. Transitions between different interaction states, or movements from an application state are also handled by the dynamic display engine. The application layout state may include an optimal layout state—the developer's desired display when a user is in a “best” interaction state as defined by the developer—as well as numerous other application layout states based on specific interaction states or based on changes (or movements) by a user relative to previous states of the user.

More information about recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

FIG. 3 is a flowchart describing one embodiment of a process for gesture control of a user interface as can be performed by tracking system 10 in one embodiment. At step 402, processor 42 of the capture device 20 receives a visual image and depth image from the image capture component 32. In other examples, only a depth image is received at step 402. In still other examples, only a visual image is received at step 402. The depth image and visual image can be captured by any of the sensors in image capture component 32 or other suitable sensors as are known in the art. In one embodiment the depth image is captured separately from the visual image. In some implementations the depth image and visual image are captured at the same time while in others they are captured sequentially or at different times. In other embodiments the depth image is captured with the visual image or combined with the visual image as one image file so that each pixel has an R value, a G value, a B value and a Z value (representing distance).

At step 404 depth information corresponding to the visual image and depth image are determined. The visual image and depth image received at step 402 can be analyzed to determine depth values for one or more targets within the image. Capture device 20 may capture or observe a capture area that may include one or more targets. At step 406, the capture device determines whether the depth image includes a human target. In one example, each target in the depth image may be flood filled and compared to a pattern to determine whether the depth image includes a human target. In one example, the edges of each target in the captured scene of the depth image may be determined. The depth image may include a two dimensional pixel area of the captured scene for which each pixel in the 2D pixel area may represent a depth value such as a length or distance for example as can be measured from the camera. The edges may be determined by comparing various depth values associated with for example adjacent or nearby pixels of the depth image. If the various depth values being compared are greater than a pre-determined edge tolerance, the pixels may define an edge. The capture device may organize the calculated depth information including the depth image into Z layers or layers that may be perpendicular to a Z-axis extending from the camera along its line of sight to the viewer. The likely Z values of the Z layers may be flood filled based on the determined edges. For instance, the pixels associated with the determined edges and the pixels of the area within the determined edges may be associated with each other to define a target or a physical object in the capture area.

At step 408, the capture device scans the human target for one or more body parts. The human target can be scanned to provide measurements such as length, width or the like that are associated with one or more body parts of a user, such that an accurate model of the user may be generated based on these measurements. In one example, the human target is isolated and a bit mask is created to scan for the one or more body parts. The bit mask may be created for example by flood filling the human target such that the human target is separated from other targets or objects in the capture area elements. At step 410 a model of the human target is generated based on the scan performed at step 408. The bit mask may be analyzed for the one or more body parts to generate a model such as a skeletal model, a mesh human model or the like of the human target. For example, measurement values determined by the scanned bit mask may be used to define one or more joints in the skeletal model. The bitmask may include values of the human target along an X, Y and Z-axis. The one or more joints may be used to define one or more bones that may correspond to a body part of the human.

According to one embodiment, to determine the location of the neck, shoulders, or the like of the human target, a width of the bitmask, for example, at a position being scanned, may be compared to a threshold value of a typical width associated with, for example, a neck, shoulders, or the like. In an alternative embodiment, the distance from a previous position scanned and associated with a body part in a bitmask may be used to determine the location of the neck, shoulders or the like.

In one embodiment, to determine the location of the shoulders, the width of the bitmask at the shoulder position may be compared to a threshold shoulder value. For example, a distance between the two outer most Y values at the X value of the bitmask at the shoulder position may be compared to the threshold shoulder value of a typical distance between, for example, shoulders of a human. Thus, according to an example embodiment, the threshold shoulder value may be a typical width or range of widths associated with shoulders of a body model of a human.

In another embodiment, to determine the location of the shoulders, the bitmask may be parsed downward a certain distance from the head. For example, the top of the bitmask that may be associated with the top of the head may have an X value associated therewith. A stored value associated with the typical distance from the top of the head to the top of the shoulders of a human body may then added to the X value of the top of the head to determine the X value of the shoulders. Thus, in one embodiment, a stored value may be added to the X value associated with the top of the head to determine the X value associated with the shoulders.

In one embodiment, some body parts such as legs, feet, or the like may be calculated based on, for example, the location of other body parts. For example, as described above, the information such as the bits, pixels, or the like associated with the human target may be scanned to determine the locations of various body parts of the human target. Based on such locations, subsequent body parts such as legs, feet, or the like may then be calculated for the human target.

According to one embodiment, upon determining the values of, for example, a body part, a data structure may be created that may include measurement values such as length, width, or the like of the body part associated with the scan of the bitmask of the human target. In one embodiment, the data structure may include scan results averaged from a plurality depth images. For example, the capture device may capture a capture area in frames, each including a depth image. The depth image of each frame may be analyzed to determine whether a human target may be included as described above. If the depth image of a frame includes a human target, a bitmask of the human target of the depth image associated with the frame may be scanned for one or more body parts. The determined value of a body part for each frame may then be averaged such that the data structure may include average measurement values such as length, width, or the like of the body part associated with the scans of each frame. In one embodiment, the measurement values of the determined body parts may be adjusted such as scaled up, scaled down, or the like such that measurement values in the data structure more closely correspond to a typical model of a human body. Measurement values determined by the scanned bitmask may be used to define one or more joints in a skeletal model at step 410.

At step 412, motion is captured from the depth images and visual images received from the capture device. In one embodiment capturing motion at step 414 includes generating a motion capture file based on the skeletal mapping as will be described in more detail hereinafter. At 414, the model created in step 410 is tracked using skeletal mapping and to track user motion at 416. For example, the skeletal model of the user 18 may be adjusted and updated as the user moves in physical space in front of the camera within the field of view. Information from the capture device may be used to adjust the model so that the skeletal model accurately represents the user. In one example this is accomplished by one or more forces applied to one or more force receiving aspects of the skeletal model to adjust the skeletal model into a pose that more closely corresponds to the pose of the human target and physical space.

At step 416 user motion is tracked. At step 418 motion data is provided to an application, such as any application using a display 16 system as described herein. Such motion data may further be evaluated to determine whether a user is performing a pre-defined gesture.

In one embodiment, steps 416-418 are performed by computing environment 12. Furthermore, although steps 402-414 are described as being performed by capture device 20, various ones of these steps may be performed by other components, such as by computing environment 12. For example, the capture device 20 may provide the visual and/or depth images to the computing environment 12 which will in turn, determine depth information, detect the human target, scan the target, generate and track the model and capture motion of the human target.

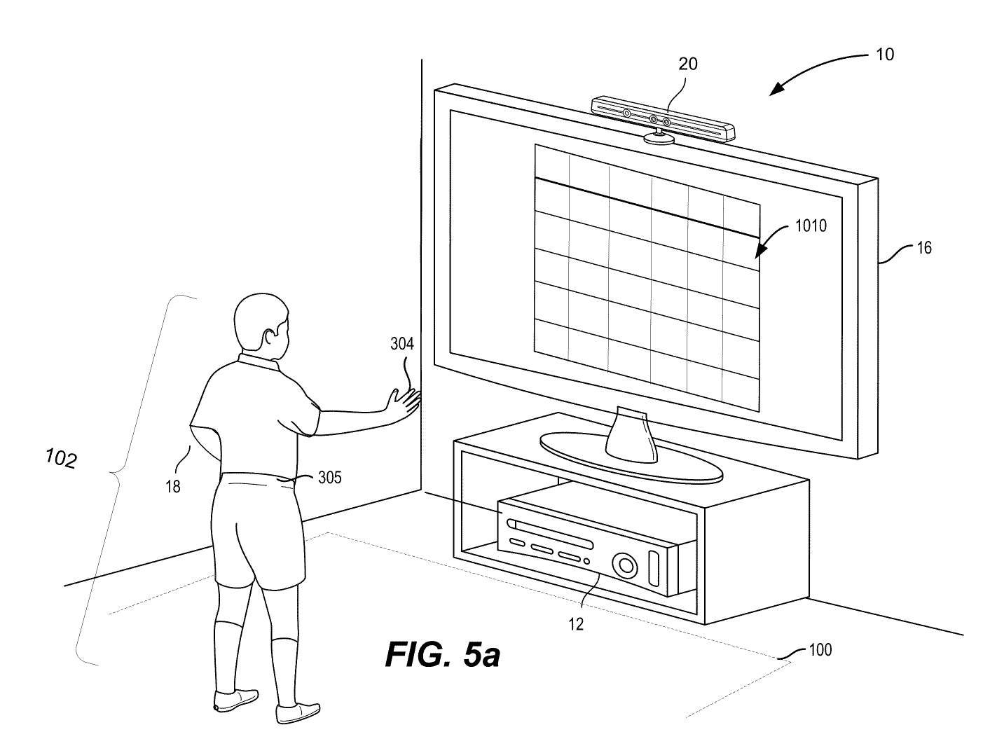

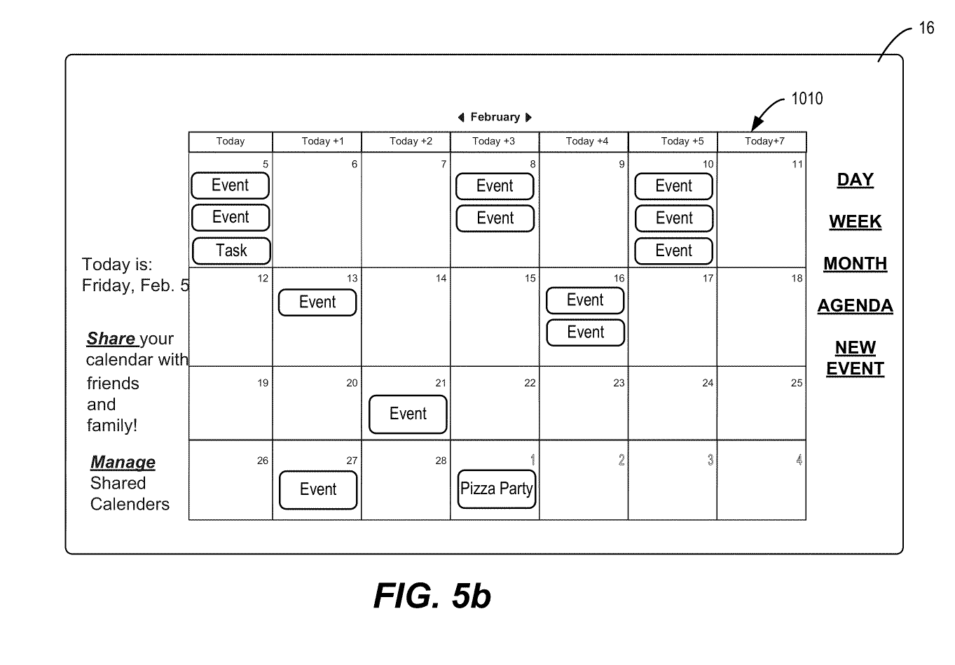

FIG. 5 is a method of performing the present technology. At step 450, user interaction states are defined. User interaction states reflect, for example, a user's intent or lack thereof, to interact with a display as determined by a developer of the application (or operating system) in control of the display. The interaction states may include data reflecting one or more of a user's body position, body orientation, body range, head range, head position, head orientation, dwell time for each of the range/orientation/positions, user motion (including user appendage motion), user posture, user gaze and user auditory cues. It should be understood that the aforementioned list of factors in non-exhaustive.

User interaction states may be defined by an application developer, the provider of the operating system, or any party with control a processing device controlling rendering of information on a display such as display 16.

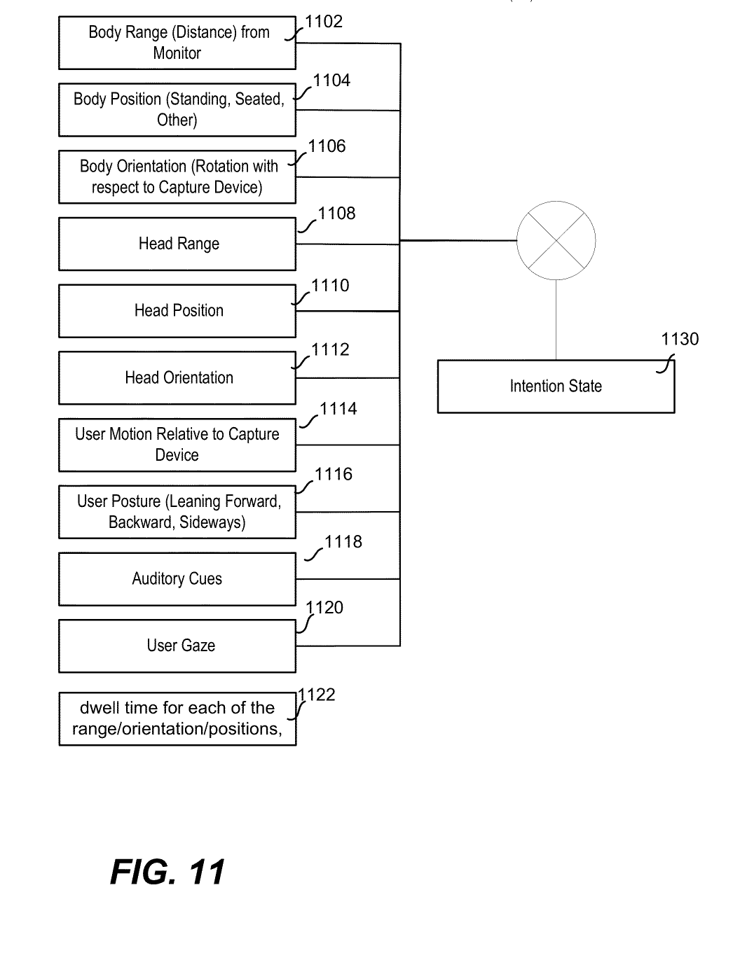

At step 452, application layout states for each interaction state defined at step 450 are defined. The application layout states include display information may be directly associated with each interaction state, or may provide a change or alteration to an existing layout state which depends on a change in any one of the factors which comprise interaction states. Factors which comprise interaction states are set forth below in FIG. 11.

Once interaction states are defined at step 450, and application layout states for the interaction states are defined at 452, user tracking data can be retrieved at step 454 to determine whether or not the user is in an interaction states at step 456.

At 456, a determination is made based on use of the tracking information and the interaction state definitions as to whether not a user occupies an interaction state. If a comparison of the factors defined for an interaction state match the retrieved data for a user, the user is found to be in an interaction state and at 458, an associated application layout state is retrieved. As indicated by the loop between steps 454 and 456, the technology continuously checks for changes in the tracking information that indicate a different interaction state or a transition from an interaction state to a different state. At step 460, the associated display layout information is used to render the display based on the layout information in the user's position in the interaction state.

If a user is present in the field of view or environment 100 and no interaction state is defined for the application controlling the display, or if an interaction state is defined but the interaction state has no associated application layout state, a default application layout state for the application may be used. Additional detail on the foregoing processes set forth in FIGS. 5A through 13.

FIGS. 5A through 13 illustrate the effect of a user's change in position, orientation, and range relative to the dynamic information presented on display 16.

FIG. 5A illustrates a user 18 in a first interaction state 102 before a display 16. In this example, the interaction state may be based on user's position within the field of view or environment 100 of the capture device 20, facing the display 16, and further judged by user movement of the user's arm 304 indicating that the user is actively engaged with the display 16. Multiple factors can be used to define this interaction state including the user's two dimensional position within the zone 100, the users distance or range from the display 16, the user's orientation facing the display 16, the user's head and body facing the display 16, the fact that the user is standing, and the motion of the user's arm. In this example a calendar application is presented on display 16, further detail of which is illustrated in FIG. 5B. As illustrated in FIG. 5B, a month view of a calendar shows a series of events having sparse event detail. The font on the events is presented and sufficient size to allow the user the position illustrated in FIG. 5A to view the text on the screen to manipulate objects on the screen using the capture device with a natural user interface. The interface includes a set of controls allowing the user to select different views (“day,” “week,” “month,” “agenda”) as well as manage shared calendars with others. The information presented as well as the set of controls made available may all be defined in the application layout state, in addition, the size of the form and amount of detail presented in the application represent a layout state.

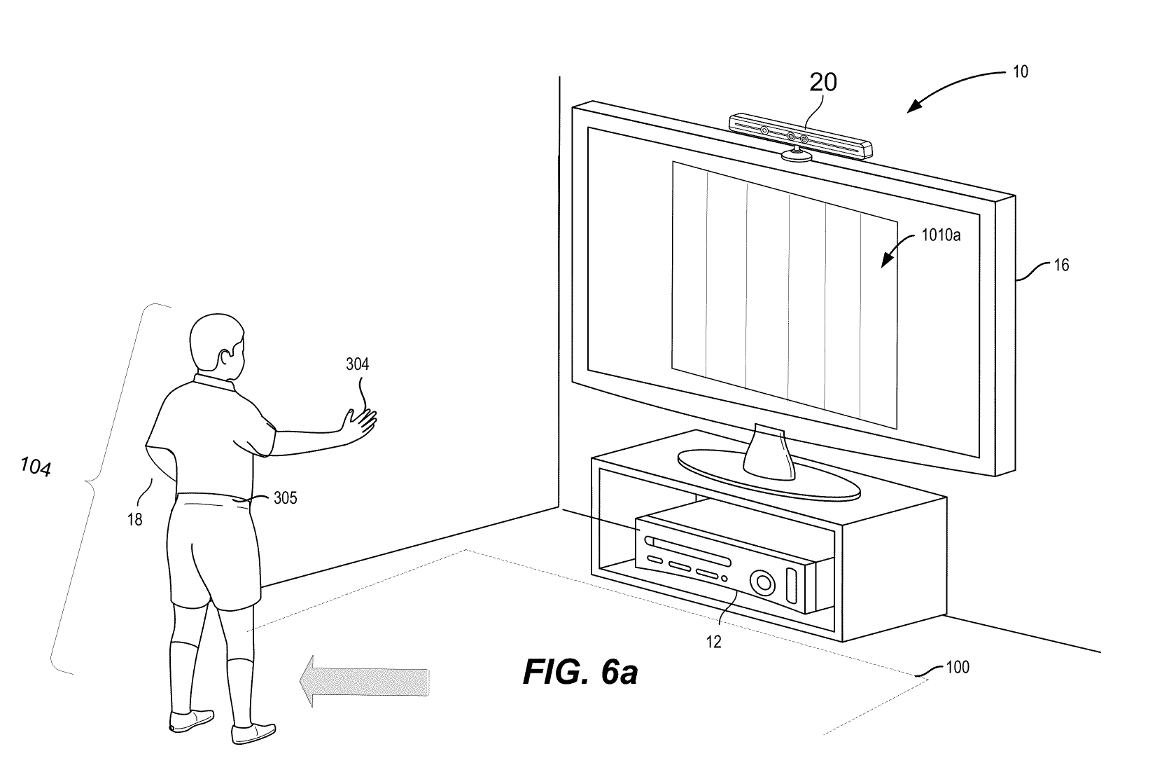

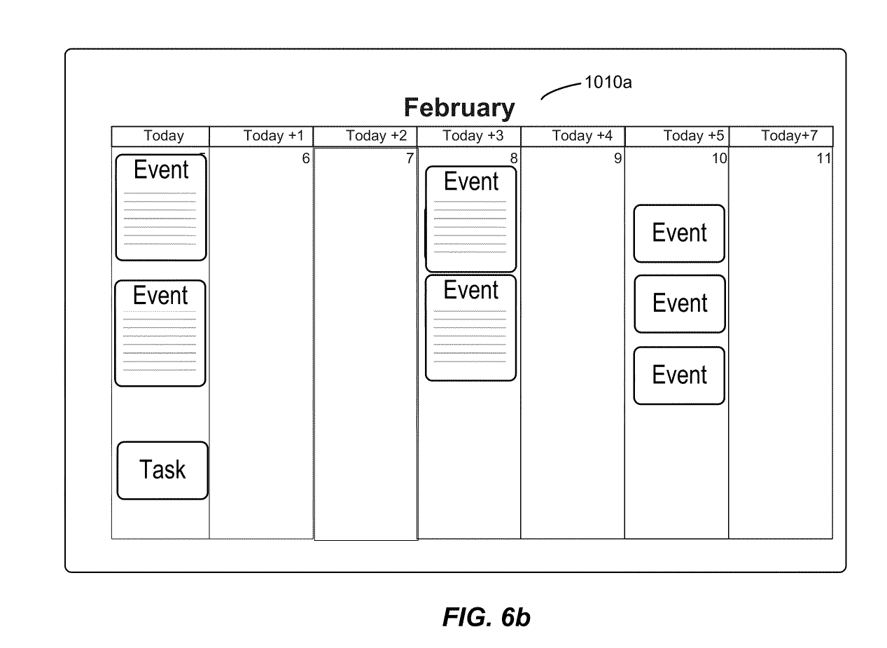

In FIG. 6A, a user 18 has moved to a second interaction state 104. As illustrated in FIG. 6A, the second interaction state 104 is farther away from, and offset with respect to, state 102 and the center of display 16. The user's movement to the second interaction state 104 can be tracked by capture device 20 and processing environment 12.

In one example, where a user 18 was previously in an interaction state (102) and moves to an application state (104), a transition event occurs. Transition events may be indicated by a change in any one or more of the factors defining an interaction state. In one example, a change in the user's distance may result in a change of an interaction state.

In addition, as discussed further below, transition events may be controlled by introducing hysteresis between the amounts of change needed on any factor to result in a transition event. For example, if the user was in interaction state 102 and moves to state 104, a transition event may result from the user's movement beyond a threshold distance defined in an interaction state. Hysteresis may be introduced either in the definition or under the control of the dynamic display engine to ensure that changes to the factor do not result in rapid or unwanted changes in interaction state and application layout state. In the foregoing example, if the user moves backward by an amount equal to the threshold distance sufficient to result in a transition event between states 102 and 104, more or less distance may be added to the threshold distance used for a reverse movement of the user to fire a transition event.

Where the display is initialized at either states 102, 104, or any position, the factors defining the interaction state and the dynamic display layout are used to determine which application layout state to be presented on display 16. Transition events can also be used to make changes to the application layout state.

As shown in FIG. 6A, the calendar display has changed. The format of the calendar has changed from monthly calendar to a weekly calendar, the font on the event indicators has been increased, and controls which were present in the display shown in FIG. 5B are no longer available. Additional details for events may be presented on weekly calendar 1010a as illustrated FIG. 6B. In this Example, the developer may have decided that a user's movement too far from the display 16 means that the user is less engaged with the application, and the distance means that the user should see a larger font size to enable user to view items of interest on the calendar.

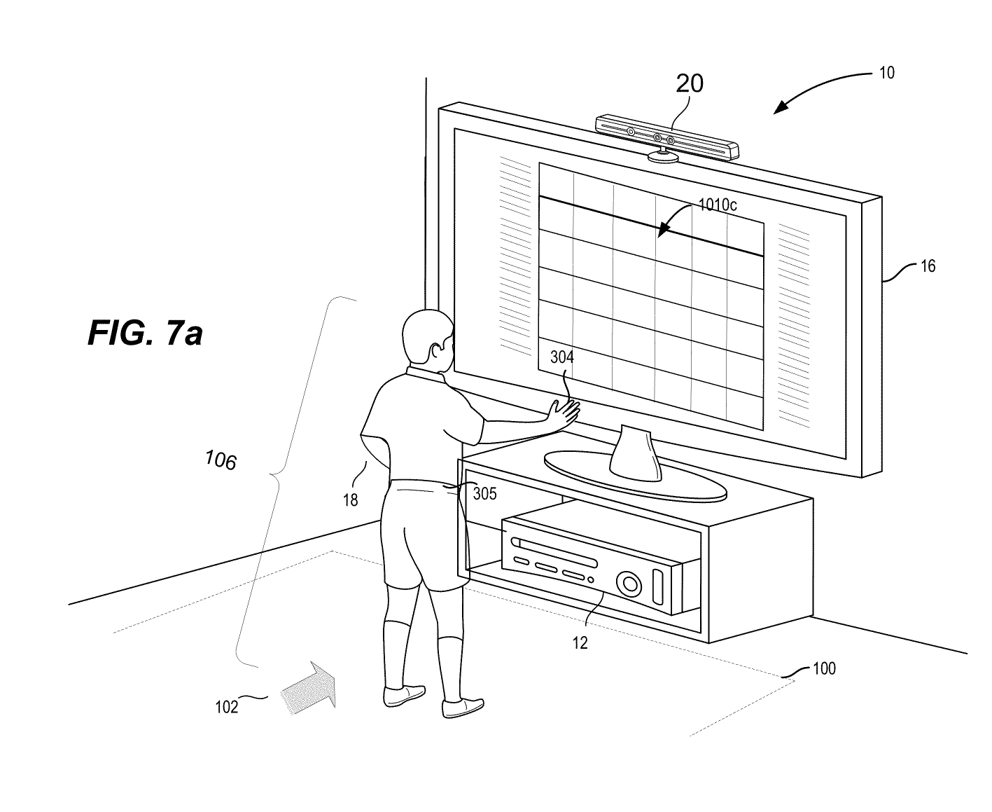

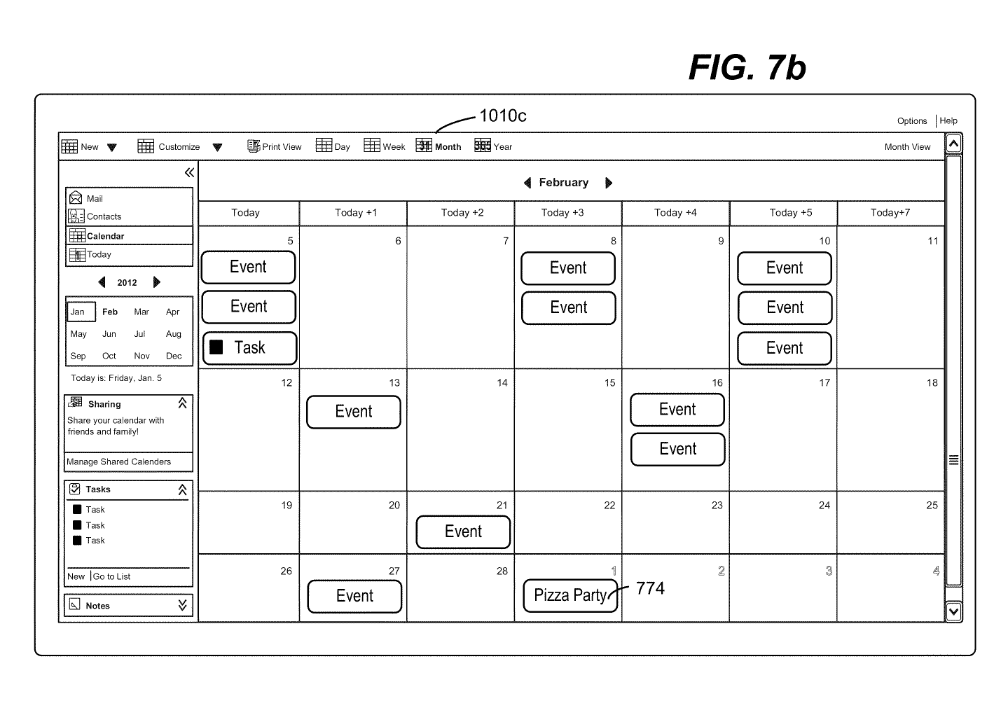

FIG. 7A illustrates user 18 in another interaction state 106 where the user has moved closer to display 16. Again, the position, range, orientation, as well as body posture of the user relative to the display 16 all indicate that the user wishes to engage with the display, moving closer to the display may indicate to the developer that the user wishes to view more detail. As such, as illustrated in FIG. 7B, the calendar display changes to a more detailed view 1010c. Additional controls and menus are provided as well additional application details. Font sizes may be reduced relative to the view shown in FIGS. 5B, and 6b, since the range of the user relative to the display is much closer.

Any one of the three states illustrated in FIG. 5A, 6A, or 7A can comprise an default interaction state relative to the user's position orientation posture, etc., and relative to the display defined by a developer for the application.

As can be noted from the foregoing examples, an application layout state can include not only the definition of which objects are to be presented in a particular layout relative to the interaction state, but the sizes of the objects, the perspective of the objects, the position of the objects, as well as any other of a number of factors and functionality for a given application. Application layout states may include one or more of the following: objects which may be displayed, fonts, font sizes, application objects to be displayed, format of application objects displayed, resolution of display or objects, controls presented, interactions presented/allowed, alternative interfaces presented/allowed and the like.

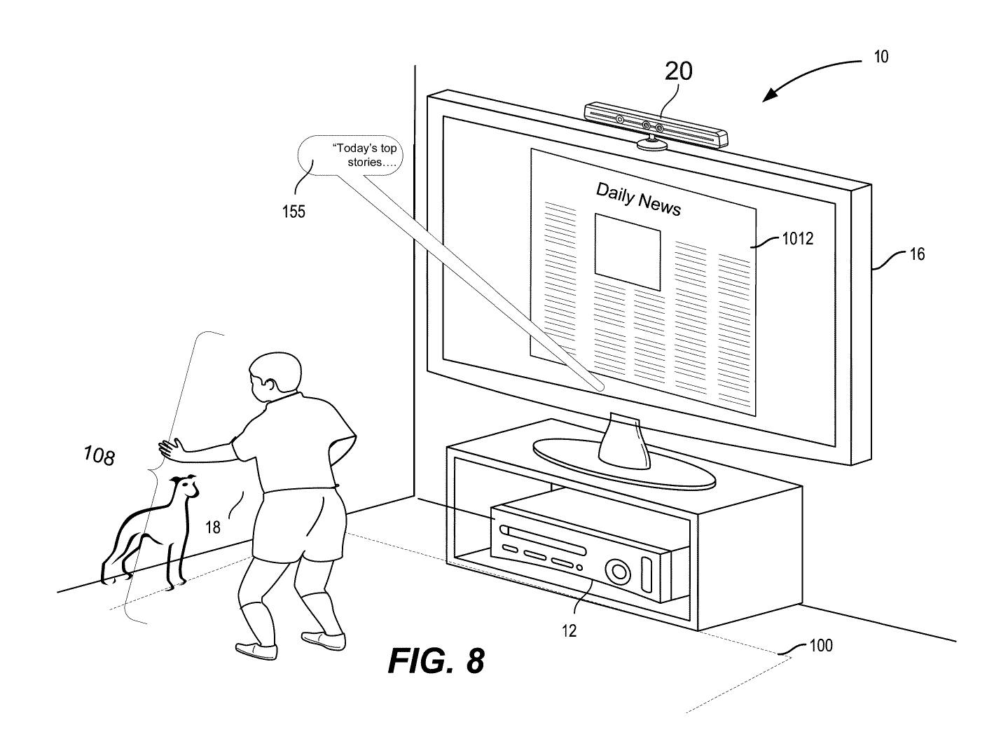

While FIGS. 5A-7B illustrate the change in a user's position relative to display 16, FIG. 8 illustrates an interaction state where the user's orientation relative to display 16 has changed. FIG. 8 also illustrates this factor change relative to a different type of application on display 16. In the example shown in FIG. 8, display 16 shows a news application presenting a news application 1012 on the display. Interaction state 108 has changed in multiple respects relative to interaction state 102. The user's orientation has been rotated 45° relative to display 16. In addition, the user is in a squatting posture rather than standing fully correct. As the system has detected that the user has turned away from the display 16, the application layout state of the news application 1012 can reflect interaction state 108 by changing the application layout state. As illustrated in FIG. 8, additional functionality such as text-to-speech rendering of the articles in the daily news can be provided indicated by balloon 155. In this instance, the orientation of the user relative to the display and/or the user's posture may be used to engage an additional functionality which is defined in the application layout state information for the application.

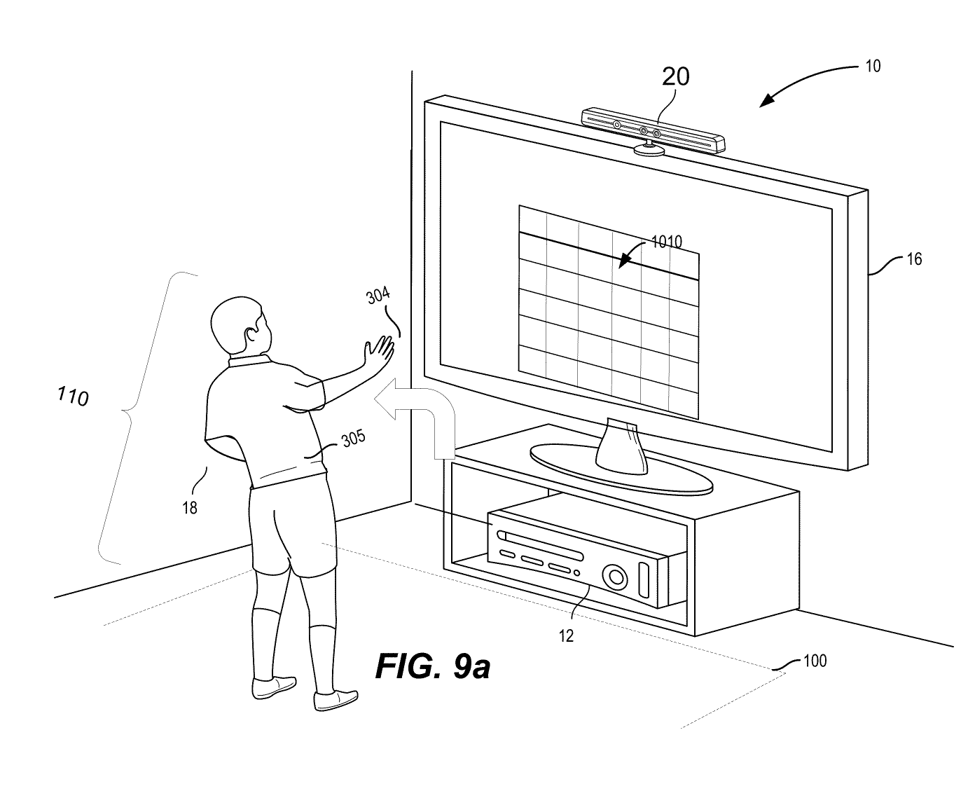

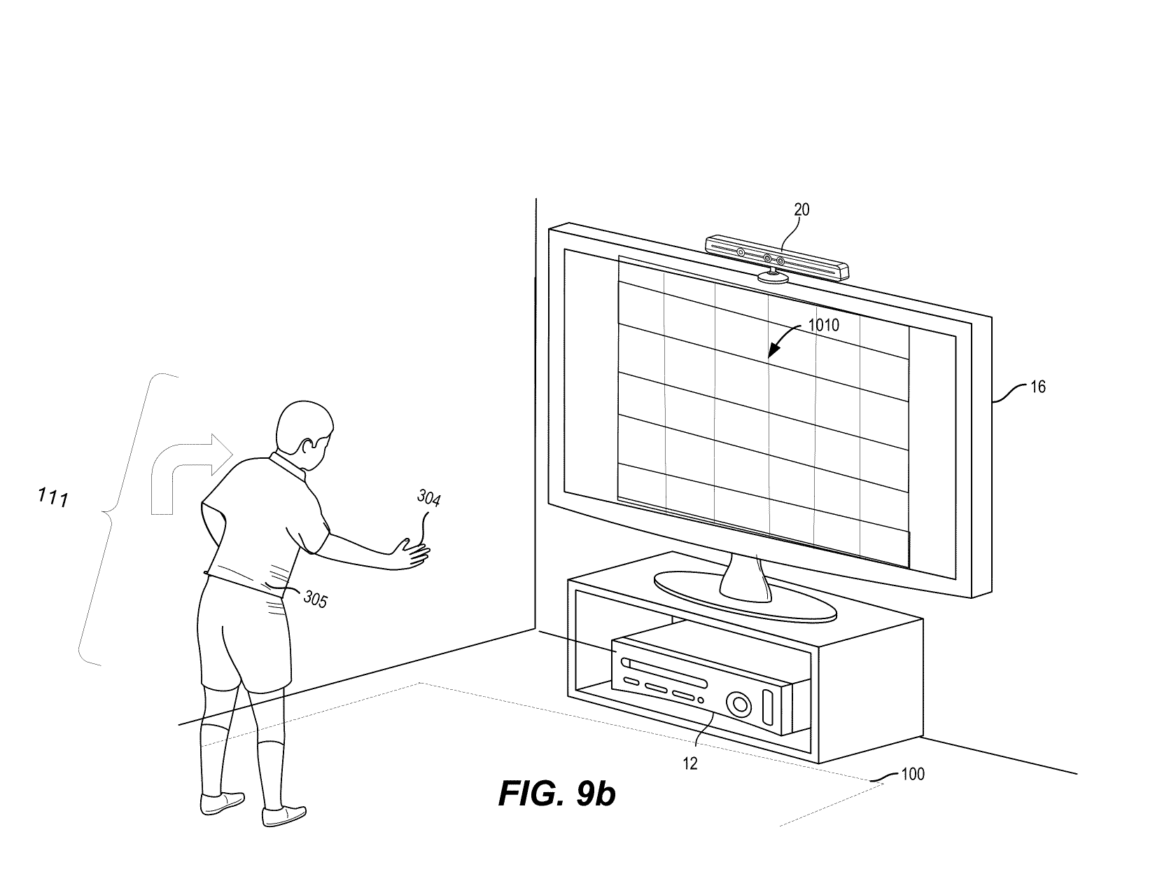

FIGS. 9A and 9B illustrate changes in user posture which can affect the interaction state and associated application layout state. FIG. 9A, user 18 is illustrated in an interaction state 110. The posture of the user as leaning back, but at a point in the field of view of the capture devices which may be the same x-y position as the state 102 changes state 110 of FIG. 9A with respect to state 102. As a result of the users leaning back from the display 16, a transition event between interaction states may occur, and the calendar application presentation 110d on display 16 as illustrated in FIG. 9A will be presented smaller than, for example, presentation 1010 in FIG. 5B. In addition, the location of the application has changed from being centered, as in FIG. 5B, to be offset with respect to the center as illustrated in FIG. 9A. Similarly, FIG. 9B illustrates a user leaning forward in posture, which results in a different transition event and a different interaction state. For example, such a posture may indicate that the user is trying to see items on the display more clearly by “leaning in.” and hence the application layout state is defined to display an enlarged view relative to the user.

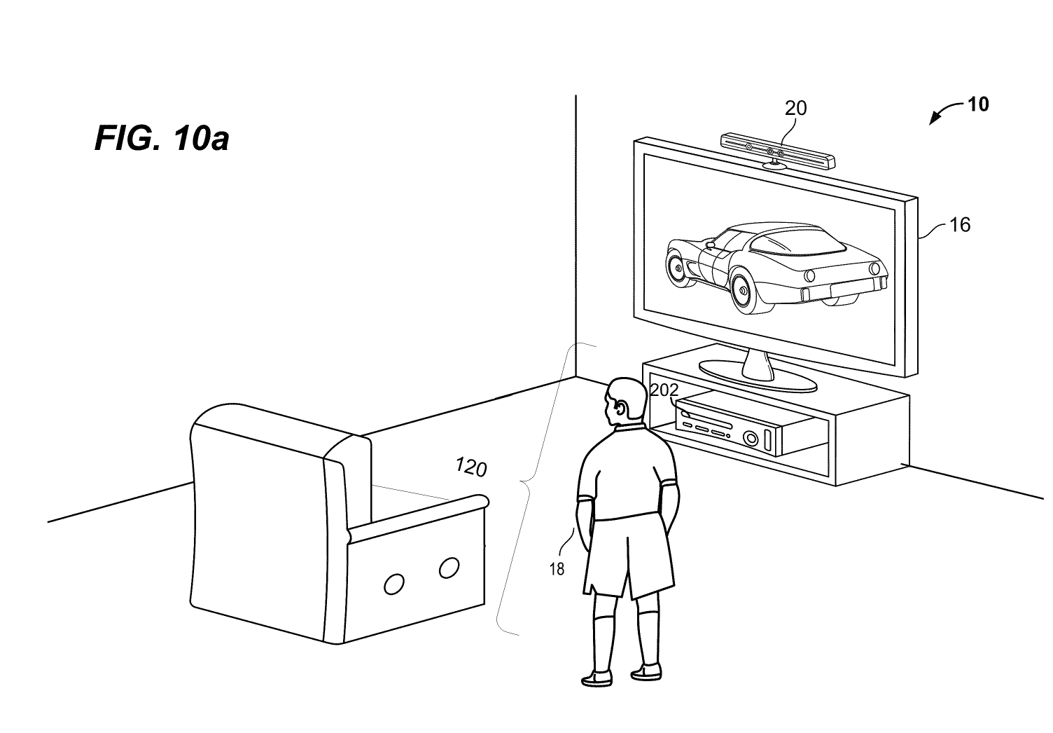

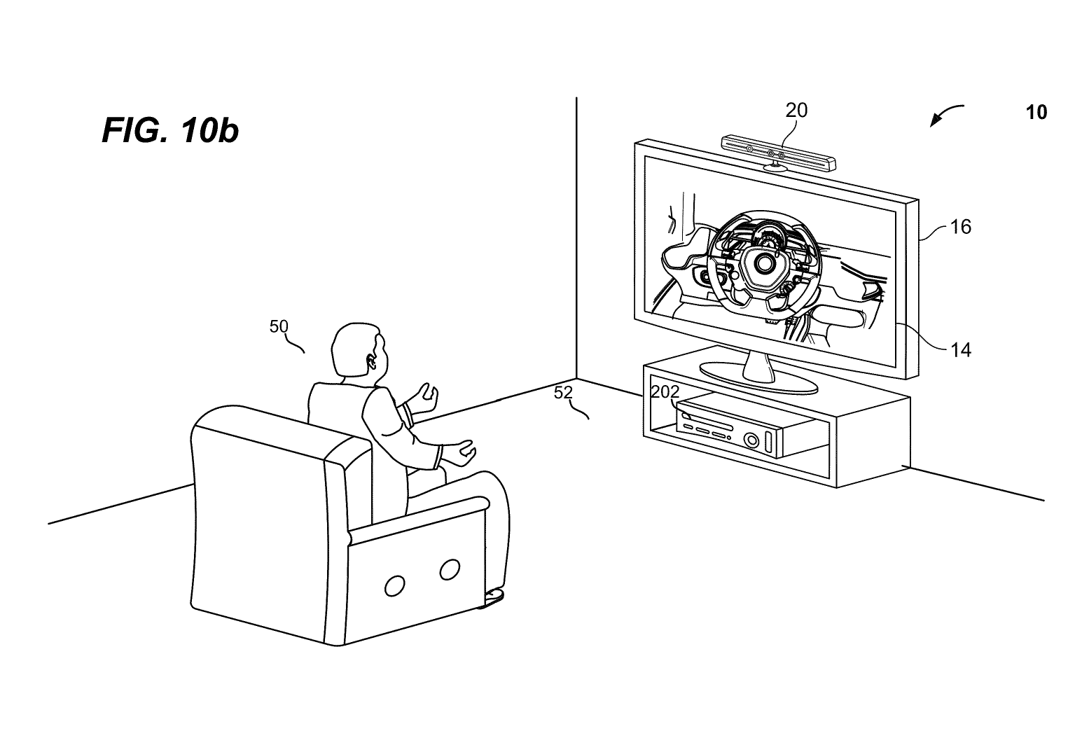

FIGS. 10a and 10b illustrate in another example of an interaction state relative. In the example shown in FIGS. 10 A and ten B, a gaming application presents the view of a car 1014 on display 16 when a user 18 is in an interaction state 120. In interaction state 120, user 18 is neither facing the display 16, Lourdes the user. The actively engaged with the display 16. In FIG. 10B, user 18 sits in a chair facing the display, and a driving interface is presented based on the user's change to the interaction state defined by the proximity, posture and other factors discussed above. In this example, the application may not be enabled for use in different modes (e.g. driving modes) until a user is in a defined interaction state.

Interaction states can be used to attract users in various types of business scenarios. For example, developers may place applications in one or more attraction modes to entice user interaction, with such modes changing as a user is determined to be engaged with the display based on the user's occupying an interaction state.

FIG. 11 illustrates how an interaction state may be defined. FIG. 11 represents one manner of performing step 450 in FIG. 4. A number of factors 1102 through 1122 makeup an interaction state 1130. Each of the factors may have an absolute value definition or be defined in terms of a range. Illustrated in FIG. 11 are factors including: the user's body range or distance 1102 from the display, the user's body position (standing seated or other) relative to the display 1104, the user's body orientation 1106 (the user's rotation with respect to the display), the range of the user's head 1108, the position of the user's head 1110, the orientation of the user's head 1112, whether the user or parts of the user are in motion relative to the display, the user's posture 1116 (whether the user is meaningful, backward, or sideways), whether the user emits auditory cues 1118, the direction and focus of the user's gaze 1120, and the user's time in each of the aforementioned factors 1122. It should be understood that the dwell time for each of the factors 1102 through 1120 may be associated with that factor directly. Each of the factors alone or in combination can be utilized in an interaction state definition. Alternatively, a subset of the factors (for example simply range alone, or orientation alone) may make up an interaction state definition at 1130. The summing node shown in FIG. 11 is used to illustrate that any one or more of the factors 1102 through 1122 may be used to define the interaction state 1130.

Interaction states 1130 may be defined by the application developer, or may be provided in the operating system. In order to assist developers of applications with utilizing application states, a provider of the operating system illustrated in FIG. 2 may create one or more default interaction states, and an interface allowing users to develop their own customized application states by defining values for each of the factors illustrated in FIG. 11. Alternatively, the operating system provider may provide default application states allowing the developer to simply associate dynamic layout with interaction states for the application.

Application layout states may be controlled by the operating system directly or by an application which is in control of the display 16. Certain application states may take priority over other application states. For example, an operating system may have defined a series of application states indicating whether or not a monitor or processing device twelve may even be engaged, preventing an application from accessing the display if the operating system has determined that the user is not in interaction state suitable for use of the device. Alternatively, full control over the display may be turned over to a running application.

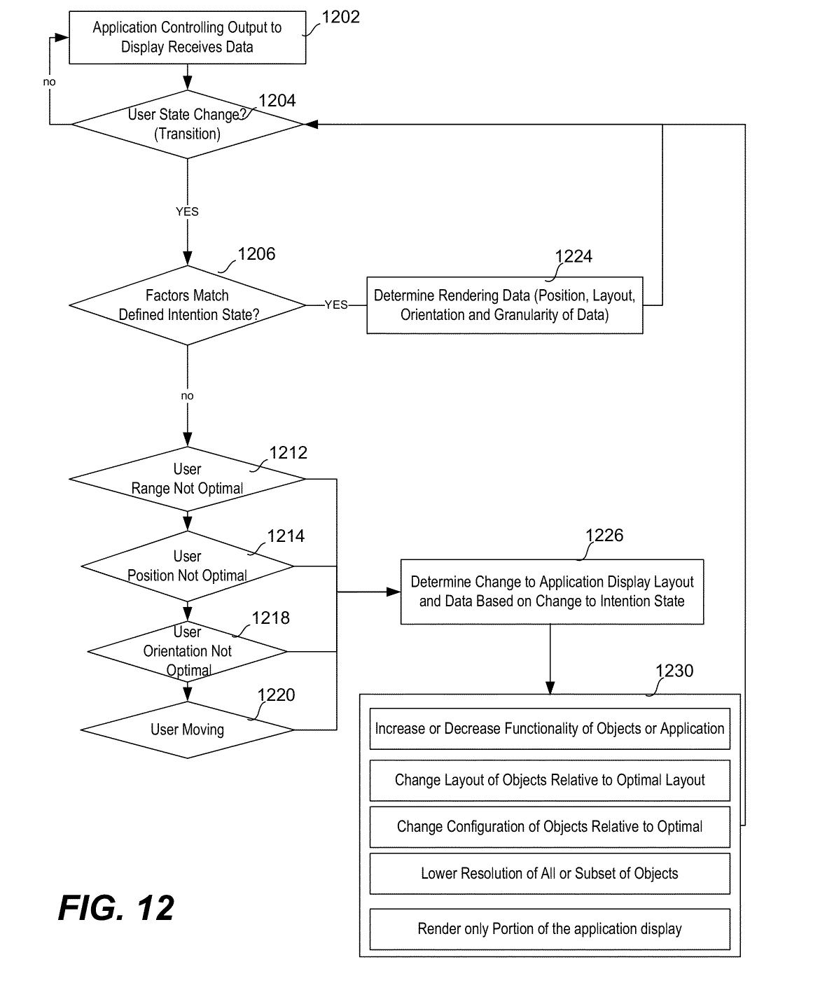

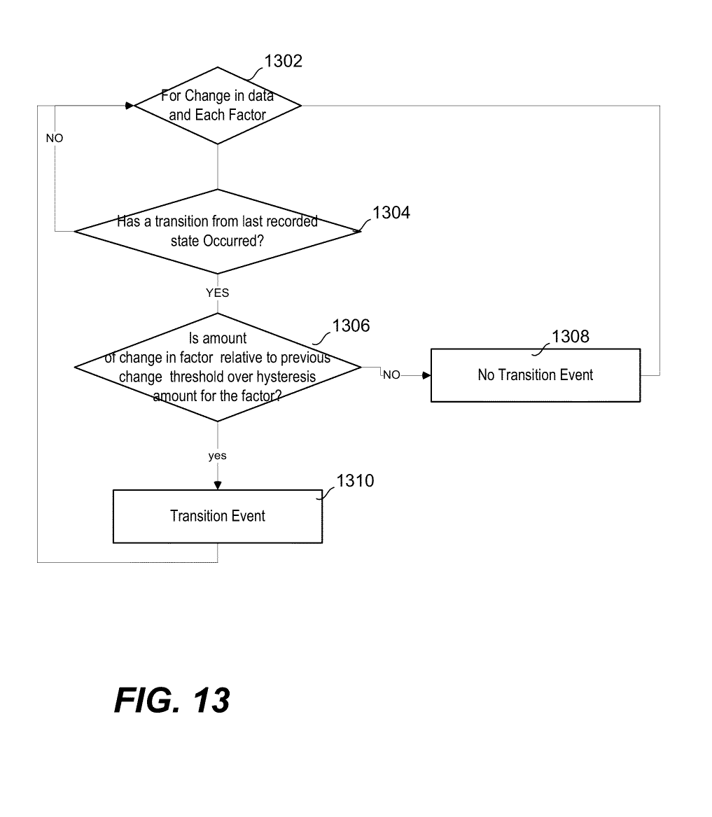

FIG. 12 illustrates a method of determining whether a user is in an interaction state and associated layout states FIG. 12 represents one method of performing steps 456 and 458 in FIG. 4. At 1202, the application or operating system controlling output to a display receives tracking data as discussed above. At step 1204, determination is made as to whether not the user's state has changed. A state change is indicted by a transition event which may constitute a change in any one or more of the factors discussed herein as defining an interaction state. Determination of a transition is discussed further below in FIG. 13.

At step 1206, the detected tracking information is compared to interaction state definitions to determine if a match occurs and the user is in an interaction state. Detection of the interaction state at 1206 comparing each of the factors for which data has been received against an interaction state definition such as when illustrated in FIG. 11. If one or more of the factors making up an interaction state definition is present, a determination is made at step 1206 as to whether not the received data indicates that the user is, for example, fully engaged in position to see all the data which a developer wishes to present. If so, then at step 1224, the application layout state matching the interaction state for the application is selected. In one alternative embodiment, partial matches between interaction states and detected data may be allowed.

If a transition event has occurred but no matching interaction state has been determined at 1206, variance in the factors can be used under control of the operating system or the application to alter the application layout. For example, at step 1212, a determination can be made as to whether not the user's range is too close or too far and hence not optimal. Similarly at 1214, a determination of a non-optimal position can be made. At step 1218, a determination as to whether not these orientation is not optimal can be made, while at 1220, a determination to me made as to whether not the user is moving. Each of the steps 1212, 1214, 1218, and 1220, the variance (too close, too far, rotation too much, etc.) from an optimal definition in each of the factors can be used at 1226 to determine a change to the application layout state. As result, at 1230, the application developer may provide rules which, for example, increase or do you decrease the functionality of objects or the application in the display, change the layout of objects relative to the optimal layout, change the configuration of objects relative to the optimal layout, lower the resolution of all parties subset of objects, and/or render only a portion of the application display. As such, interaction states need not be specified as absolute or ranges of values relative to any one or more the factors, they can be further specified as changes to any of the factors relative to a previous state of a user.

FIG. 13 represents a method for performing step 1204 in FIG. 12. For each factor at 1302, a determination is made at 1304 is to whether not a transition from the last recorded state of that factor has occurred. If so, then at 1306, a determination is made as to whether the amount of change in the factor relative to the previous change is equal to a defined level of change plus or minus a hysteresis amount for that factor. If so, then a state changes indicated at 1310, and if not, no state change occurs at 1308. In either case, the method repeats for each change in data and for each factor. The hysteresis factor in traduced in FIG. 13 prevents state transitions from occurring in any of the interaction state definitions which may not be interactional. For example, the user moves toward a display and the range for transitioning to a different interaction state is defined at a distance of, for example, 6 feet, then the hysteresis amount introduced may be, for example, 6 inches such that a user moves at least 6′6″ toward the display before indicating a change in the interaction state. Similarly when the mood user moves back from the display, the user may move a distance of 5′6″.

FIG. 14 is a block diagram of one embodiment of a computing system that can be used to implement a hub computing system like that of FIGS. 1A and 1B. In this embodiment, the computing system is a multimedia system 800, such as a gaming console. As shown in FIG. 8, the multimedia system 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 806a. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is configured as a flash ROM that is connected to memory controller 802 via a PCI bus and a ROM bus (neither of which are shown). RAM 806 is configured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an NV (audio/video) port 828 for transmission to a television or other display. In the illustrated implementation, video and audio processing components 820-828 are mounted on module 214.

FIG. 14 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 14 system 800 includes a controller support subassembly 840 for supporting four controllers 804(1)-804(4). The controller support subassembly 840 includes any hardware and software components needed to support wired and wireless operation with an external control device, such as for example, a media and game controller. A front panel I/O subassembly 842 supports the multiple functionalities of power button 812a, the eject button 813, as well as any LEDs (light emitting diodes) or other indicators exposed on the outer surface of console 800. Subassemblies 840 and 842 are in communication with module 814 via one or more cable assemblies 844. In other implementations, system 800 can include additional controller subassemblies. The illustrated implementation also shows an optical I/O interface 835 that is configured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be configured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into system 800 or a controller, MU 840 can be accessed by memory controller 802. A system power supply module 850 provides power to the components of gaming system 800. A fan 852 cools the circuitry within system 800. A microcontroller unit 854 is also provided.

An application 860 comprising machine instructions is stored on hard disk drive 808. When system 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Gaming and media system 800 may be operated as a standalone system by simply connecting the system to display 16 (FIG. 1A), a television, a video projector, or other display device. In this standalone mode, gaming and media system 800 enables one or more players to play games, or enjoy digital media, e.g., by watching movies, or listening to music. However, with the integration of broadband connectivity made available through network interface 832, gaming and media system 800 may further be operated as a participant in a larger network gaming community.

The system described above can be used to add virtual images to a user's view such that the virtual images are mixed with real images that the user see. In one example, the virtual images are added in a manner such that they appear to be part of the original scene. Examples of adding the virtual images can be found U.S. patent application Ser. No. 13/112,919, “Event Augmentation With Real-Time Information,” filed on May 20, 2011; and U.S. patent application Ser. No. 12/905,952, “Fusing Virtual Content Into Real Content,” filed on Oct. 15, 2010; both applications are incorporated herein

FIG. 15 illustrates another example embodiment of a computing system 1520 that may be the computing environment 12 shown in FIGS. 1A-2B used to track motion and/or animate (or otherwise update) an avatar or other on-screen object displayed by an application. The computing system environment 1520 is only one example of a suitable computing system and is not intended to suggest any limitation as to the scope of use or functionality of the presently disclosed subject matter. Neither should the computing system 1520 be interpreted as having any dependency or requirement relating to any one or combination of components illustrated in the exemplary operating system 1520. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 1520 comprises a computer 1541, which typically includes a variety of computer readable media. Computer readable media can be any available media that can be accessed by computer 1541 and includes both volatile and nonvolatile media, removable and non-removable media. The system memory 1522 includes computer storage media in the form of volatile and/or nonvolatile memory such as read only memory (ROM) 1523 and random access memory (RAM) 1560. A basic input/output system 1524 (BIOS), containing the basic routines that help to transfer information between elements within computer 1541, such as during start-up, is typically stored in ROM 1523. RAM 1560 typically contains data and/or program modules that are immediately accessible to and/or presently being operated on by processing unit 1559. By way of example, and not limitation, FIG. 9 illustrates operating system 1525, application programs 1526, other program modules 1527, and program data 1528.

The computer 1541 may also include other removable/non-removable, volatile/nonvolatile computer storage media. By way of example only, FIG. 9 illustrates a hard disk drive 1538 that reads from or writes to non-removable, nonvolatile magnetic media, a magnetic disk drive 1539 that reads from or writes to a removable, nonvolatile magnetic disk 1554, and an optical disk drive 1540 that reads from or writes to a removable, nonvolatile optical disk 1553 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1538 is typically connected to the system bus 1521 through an non-removable memory interface such as interface 1534, and magnetic disk drive 1539 and optical disk drive 1540 are typically connected to the system bus 1521 by a removable memory interface, such as interface 1535.

The drives and their associated computer storage media discussed above and illustrated in FIG. 15, provide storage of computer readable instructions, data structures, program modules and other data for the computer 1541. In FIG. 15, for example, hard disk drive 1538 is illustrated as storing operating system 1558, application programs 1557, other program modules 1556, and program data 1555. Note that these components can either be the same as or different from operating system 1525, application programs 1526, other program modules 1527, and program data 1528. Operating system 1558, application programs 1557, other program modules 1556, and program data 1555 are given different numbers here to illustrate that, at a minimum, they are different copies. A user may enter commands and information into the computer 1541 through input devices such as a keyboard 1551 and pointing device 1552, commonly referred to as a mouse, trackball or touch pad. Other input devices (not shown) may include a microphone, joystick, game pad, satellite dish, scanner, or the like. These and other input devices are often connected to the processing unit 1559 through a user input interface 1536 that is coupled to the system bus, but may be connected by other interface and bus structures, such as a parallel port, game port or a universal serial bus (USB). The cameras 226, 228 may define additional input devices for the computing system 1520 that connect via user input interface 1536. A monitor 1542 or other type of display device is also connected to the system bus 1521 via an interface, such as a video interface 1532. In addition to the monitor, computers may also include other peripheral output devices such as speakers 1544 and printer 1543, which may be connected through a output peripheral interface 1533.

The computer 1541 may operate in a networked environment using logical connections to one or more remote computers, such as a remote computer 1546. The remote computer 1546 may be a personal computer, a server, a router, a network PC, a peer device or other common network node, and typically includes many or all of the elements described above relative to the computer 1541, although only a memory storage device 1547 has been illustrated in FIG. 9. The logical connections depicted include a local area network (LAN) 1545 and a wide area network (WAN) 1549, but may also include other networks. Such networking environments are commonplace in offices, enterprise-wide computer networks, intranets and the Internet.

When used in a LAN networking environment, the computer 1541 is connected to the LAN 1545 through a network interface or adapter 1537. When used in a WAN networking environment, the computer 1541 typically includes a modem 1550 or other means for establishing communications over the WAN 1549, such as the Internet. The modem 1550, which may be internal or external, may be connected to the system bus 1521 via the user input interface 1536, or other appropriate mechanism. In a networked environment, program modules depicted relative to the computer 1541, or portions thereof, may be stored in the remote memory storage device. By way of example, and not limitation, FIG. 15 illustrates application programs 1548 as residing on memory device 1547. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method of optimizing an experience with a processor controlled display, comprising:
tracking a human body in three dimensional space relative to a capture device;
responsive to the tracking, determining an interaction states occupied by the user human body, the interaction state defined by at least a body position and a body orientation relative to the display;
based on the interaction state, selecting an application layout state associated with the interaction state for the application, the application layout state defining application objects and a display layout for the application when the body occupies the interaction state; and
rendering application objects on the display based on the application layout state.

2. The computer implemented method of claim 1 wherein the interaction state is defined by two or more of factors selected from a body's: body position, dwell time in the body position, body orientation, dwell time in the body orientation, body range, dwell time at the body range, head range, dwell time at the head range, head position, dwell time at the head position, head orientation, dwell time at the head orientation, body motion, body appendage motion, body posture, body gaze and body auditory cues.

3. The computer implemented method of claim 2 wherein determining an interaction state includes retrieving a definition including a plurality of said factors and matching each of the factors to tracking data.

4. The computer implemented method of claim 2 wherein determining an interaction state includes retrieving a definition including a plurality of said factors and matching a subset of the factors to tracking data.

5. The computer implemented method of claim 1 further including determining a transition between the interaction state and a new interaction state based on a change in one or more of the position or orientation.

6. The computer implemented method of claim 2 further including determining a transition between the interaction state and a new interaction state based on a change in one or more of the plurality of said factors.

7. The computer implemented method of claim 6 wherein determining a transition includes determining a transition based on a change in said one or more of said factors by a first amount to generate a first transition event to the new interaction state, and determining a transition based on a change in said one or more of said factors by a second amount to return to the interaction state.

8. The computer implemented method of claim 1 wherein each application layout state includes one or more of which application objects are to be displayed sizes of the objects, perspective of the objects, the position of the objects, fonts, font sizes, a format of application objects displayed, a resolution of the display, a resolution of application objects, application controls presented, interactions presented/allowed, and alternative interfaces presented/allowed.

9. The computer implemented method of claim 1 wherein tracking is performed continuously and the determining, selecting and rendering are repeated based on a change in body position and orientation detected by tracking continuously.

10. A capture device, comprising:
an image capture device having a field of view;
a processing device coupled to the image capture device, the processing device including code instructing the processing device to:
retrieve image data of a human body in the field of view;
track the body position and movement in three dimensional space in the field of view;
determine an interaction state occupied by the body in the field of view, the interaction state defined by at least a body position and a body orientation relative to the capture device;
select an application layout state associated with the interaction state for an application executed by the processing device and in control of a display, the application layout state defining application objects and a display layout for the application when the body occupies the interaction state; and
render application objects based on the application layout state when the body is in the interaction state determined.

11. The capture device of claim 10 wherein the image data is continuously received that the code continuously tracks body position and movement performed continuously, the code determining, selecting and rendering being repeated based on a change in body position and orientation detected.

12. The capture device claim 11 wherein the interaction state is defined by two or more of factors selected from a body's: body position, dwell time in the body position, body orientation, dwell time in the body orientation, body range, dwell time at the body range, head range, dwell time at the head range, head position, dwell time at the head position, head orientation, dwell time at the head orientation, body motion, body appendage motion body posture, body gaze and body auditory cues.

13. The capture device of claim 12 further including determining a transition between the interaction state and a new interaction state based on a change in one or more of the plurality of said factors.

14. The capture device of claim 13 wherein determining a transition includes determining a transition based on a change in said one or more of the factors by a first amount to generate a first transition event to the new interaction state, and determining a transition based on a change in said one or more of said factors by a second amount to return to the interaction state.

15. The capture device of claim 14 wherein each application layout state includes one or more of which application objects are to be displayed sizes of the objects, perspective of the objects, the position of the objects, fonts, font sizes, a format of application objects displayed, a resolution of the display, a resolution of application objects, application controls presented, interactions presented/allowed, and alternative interfaces presented/allowed.

16. A depth and image capture processing device detecting movements of a body in a field of view and having an output coupled to control a display, the device including code instructing a processor to perform a method comprising:
tracking a body in three dimensional space relative to a capture device;
responsive to the tracking, determining an interaction state occupied by the body, the interaction state defined by at least a body position and a body orientation relative to the display;
selecting an application layout state associated with the interaction state for the application, the application layout state defining application objects and a display layout for the application when the body occupies the interaction state;
determining whether a transition event between the interaction state and a next interaction state has occurred by reference to one or more of a plurality of factors related to body position and orientation has changed;
responsive to the determining, determining a new interaction state occupied by the body; and
selecting a new application layout state associated with the new interaction state for the application.

17. The processing device of claim 16 wherein the interaction state is defined a plurality of factors selected from a body's: body position, dwell time in the body position, body orientation, dwell time in the body orientation, body range, dwell time at the body range, head range, dwell time at the head range, head position, dwell time at the head position, head orientation, dwell time at the head orientation, body motion, body appendage motion body posture, body gaze and body auditory cues.

18. The processing device of claim 17 wherein each application layout state includes one or more of which application objects are to be displayed sizes of the objects, perspective of the objects, the position of the objects, fonts, font sizes, a format of application objects displayed, a resolution of the display, a resolution of application objects, application controls presented, interactions presented/allowed, and alternative interfaces presented/allowed.

19. The processing device of claim 18 wherein determining a transition includes determining a transition based on a change in said one or more of the plurality of said factors by a first amount to generate a first transition event to the new interaction state, and determining a transition based on a change in said one or more of said plurality of factors by a second amount to return to the interaction state.

20. The processing device of claim 19 wherein tracking is performed continuously and the determining, selecting and rendering are repeated based on a change in body position and orientation detected by tracking continuously.
